(19) United States
(12) Patent Application Publication
(10) Pub. No.: US 2014/0116224 A1
(43) Pub. Date: May 1, 2014

(54) RECIPROCATING PARTING TOOL

(71) Applicant: Robert Bosch GmbH, Stuttgart (DE)

(72) Inventors: Wilfried Kern, Deitingen (CH); Martin Kocher, Solothurn (CH)

(73) Assignee: Robert Bosch GmbH, Stuttgart (DE)

(21) Appl. No.: 14/028,605

(22) Filed: Sep. 17, 2013

(30) Foreign Application Priority Data
Sep. 21, 2012 (DE) 10 2012 217 094.4

(51) Int. Cl. B23D 61/12

(52) U.S. Cl. CPC B23D 61/128
USPC 83/697

(57) ABSTRACT

A reciprocating parting tool includes a substantially flat parting blade which extends along a direction of travel and has a longitudinal extent along the direction of travel. The parting blade has at least one parting edge which extends substantially along the longitudinal extent and includes at least two edge sections, preferably of different longitudinal extents. At least one of the at least two edge sections is not oriented parallel to the direction of travel. At least one of the at least two edge sections, in particular the edge section with the larger of the two longitudinal extents, has a serrated knife edge with a serration spacing.

This application claims priority under 35 U.S.C. §119 to patent application no. DE 10 2012 217 094.4, filed on Sep. 21, 2012 in Germany, the disclosure of which is incorporated herein by reference in its entirety.

### BACKGROUND

The disclosure relates to a reciprocating parting tool, in particular for a machine tool.

Reciprocating parting tools having a substantially flat parting blade are already known. Reciprocating parting tools of this type, such as, for example, power hacksaw blades, in particular for compressors and/or saber saws, comprise a substantially flat parting blade which extends along a direction of travel and has a longitudinal extent L along the direction of travel. The parting blade here has at least one parting edge which extends substantially along the longitudinal extent and comprises at least two edge sections, preferably of different longitudinal extents L1, L2, of which at least one of the edge sections is not orientated parallel to the direction of travel. The working edge here is provided with saw teeth extending over at least one of the two edge sections. The known reciprocating parting tools, in particular those for use with machine tools, are suitable only to a limited extent for parting fibrous materials, such as modern fiber materials or fiber composite materials, in particular modern sound-absorbing or insulating mats or boards.

### SUMMARY

The reciprocating parting tool according to the disclosure with the characterizing features of the description below results in an advantageously rapid and simultaneously neat processing even of large quantities of modern sound-absorbing or insulating materials and therefore in a noticeable advantage in terms of time in the sound absorption or insulation of larger building projects. For this purpose, at least one of the edge sections of the parting tool, which is preferably configured in the form of a cutting knife, has a serrated knife edge with a serration spacing p. Preferably, in particular the edge section with the greater of the two longitudinal extents L1, L2 is provided with a serrated knife edge. A serrated knife edge of this type makes it advantageously possible neatly to part or cut the fibers of the relatively soft sound-absorbing or insulating material. A particularly neat cut with, at the same time, great cutting progress is achieved if a serration number WZ of the serrated knife edge is at least 40, preferably at least 60, particularly preferably between 62 and 78. The serration number WZ here is understood as meaning the entire number of individual serrations along the parting edge.

The measures cited in the description below result in advantageous developments and improvements of the features indicated in the description below.

In an advantageous development, the other edge section also has a sharpened knife edge. The latter can advantageously be configured as a smooth sharpened knife edge or as a serrated knife edge with a serration spacing p′. If a serrated knife edge is provided, the serration spacing p′ preferably substantially corresponds to the serration spacing p, and is particularly preferably identical thereto.

In an advantageous embodiment which can readily be produced, the parting blade has two flat side surfaces which lie in a plane defined by the direction of travel and the parting edge. The serrated knife edge and/or the sharpened knife edge here are/is formed at least towards one side surface, preferably towards the two side surfaces. A sharpened edge on one side can be produced cost-effectively and also can easily be resharpened, whereas a sharpened edge on two sides promises a longer surface life following sharpening.

In order to increase the stability and/or to reduce the weight of the parting blade of the parting tool according to the disclosure, the parting blade has at least one and preferably more impressions, recesses and/or cutouts in at least one of the side surfaces. In a preferred embodiment, a plurality of recesses, preferably three to five recesses, distributed substantially uniformly over the longitudinal extent L are provided in the parting blade. Said recesses are preferably surrounded by a substantially uniform border region formed by a material body of the parting blade. The impressions, recesses and/or cutouts here can advantageously be incorporated cost-effectively into the rough parting blade by means of deformation, punching and/or machining Preferred configurations of the impressions, recesses and/or cutouts can be substantially bounded by polygonal or elliptical contours. In particular, they can have a triangle-like, trapezoidal, rhombic or rectangular cross section, wherein the corners between every two contour lines or contour edges are preferably formed in a rounded manner. A contour line or contour edge here is understood as meaning in particular a line between two corner points of the contour.

In a further advantageous embodiment of the reciprocating parting tool according to the disclosure, it is provided that the two edge sections merge into each other and, at this transition, enclose an angle W of between 90° and 180°, preferably of between 120° and 170°, particularly preferably of between 120° and 140°. An embodiment of this type advantageously promotes rapid penetration into the object to be processed and/or an uninterrupted and smooth-running cut.

Particularly good penetration into the object to be processed is achieved in that the parting blade has an inconstant transverse extent, as seen over the longitudinal extent L, wherein a maximum of the transverse extent defines a blade height h of the reciprocating parting tool. Said maximum is preferably reached essentially only at one position along the longitudinal extent. Preferred embodiments are obtained by the fact that an aspect ratio of longitudinal extent L to blade height h is at least 6.0, preferably at least 7.0, particularly preferably at least 8.0. Embodiments with a longitudinal extent of over 300 mm, in particular over 320 mm and particularly preferably of over 350 mm, are particularly advantageous here. A blade height h of between 40 and 50 mm, in particular of approx. 45 mm, may also be advantageous with regard to the guidance of the cut and robustness of the parting tool.

For an advantageous balance between penetrating behavior and cutting progress following penetration, it is advantageous if the longitudinal extent L2 of the second edge section is less than 60% of the longitudinal extent L1 of the first edge section, in particular is not more than approximately 50% of the longitudinal extent L1, preferably is not more than 40% of the longitudinal extent L1, and particularly preferably is not more than 30% of the longitudinal extent L1.

For an advantageous use on a power-driven, in particular motor-driven separating apparatus, furthermore at least one end region of the parting blade is provided with a plug-in unit for inserting the reciprocating parting tool into a tool-holding fixture of the parting apparatus. The tool-holding fixture is preferably arranged on the parting apparatus so as to be drivable in an oscillating manner at least along the direction of travel, and in particular so as to be drivable by motor. A preferred parting apparatus here is configured as a power hacksaw, in particular as an electric power hacksaw.

A first particularly preferred embodiment of a parting tool according to the disclosure is distinguished in that the first edge section encloses an angle W1 of greater than 0° and smaller than 45°, in particular greater than 5° and smaller than 20°, preferably of approx. 10° with the direction of travel, and in particular is inclined away from the direction of travel by said angle W1. This promotes the cutting progress, since the parting edge is advantageously guided obliquely through the object to be processed and therefore in particular adjacent fibers are not cut simultaneously, but rather with a small time delay, thus enabling distortion of the fibers to be reduced.

An advantageous further development is distinguished in that the second edge section is curved, preferably is curved in the form of a monotonously convex section towards the direction of travel. A monotonously convex curvature here is understood as meaning in particular a curvature curve, the radius of curvature of which only changes monotonously in the mathematical sense. If the second edge section is curved in the shape of an arc of a circle, in particular is curved in the shape of an arc of a circle with a substantially constant arc radius RB, the parting tool according to the disclosure penetrates particularly effectively and at the same time substantially independently of an application angle. The arc radius BG here is preferably greater than the longitudinal extent L2 of the edge section and in particular is particularly preferably smaller at the same time than the longitudinal extent L1.

A second particularly preferred embodiment of a parting tool according to the disclosure is distinguished in that the second edge section is formed substantially rectilinearly and encloses an angle W1 of between 10° and 70°, preferably of between 20° and 60°, in particular preferably of between 30° and 50°, particularly preferably of approximately 40°, with the direction of travel. The second edge section here preferably has a sharpened knife edge.

### BRIEF DESCRIPTION OF THE DRAWINGS

Exemplary embodiments of the disclosure are illustrated in the drawings and explained in more detail in the description below. In the drawings:

FIG. 1 shows a side view of a first exemplary embodiment of a parting tool according to the disclosure,

FIG. 2a shows a sectional view through the parting blade along the line A-A in FIG. 1a,

FIG. 2b shows a sectional view through a variant of the parting blade of FIG. 1a along the line A-A,

FIG. 3 shows a side view of the detail B from FIG. 1a,

FIG. 4 shows a side view of a second exemplary embodiment of a parting tool according to the disclosure,

FIGS. 5a and 5b each show a sectional view through the parting blade along the line A-A and B-B of FIG. 4a.

### DETAILED DESCRIPTION

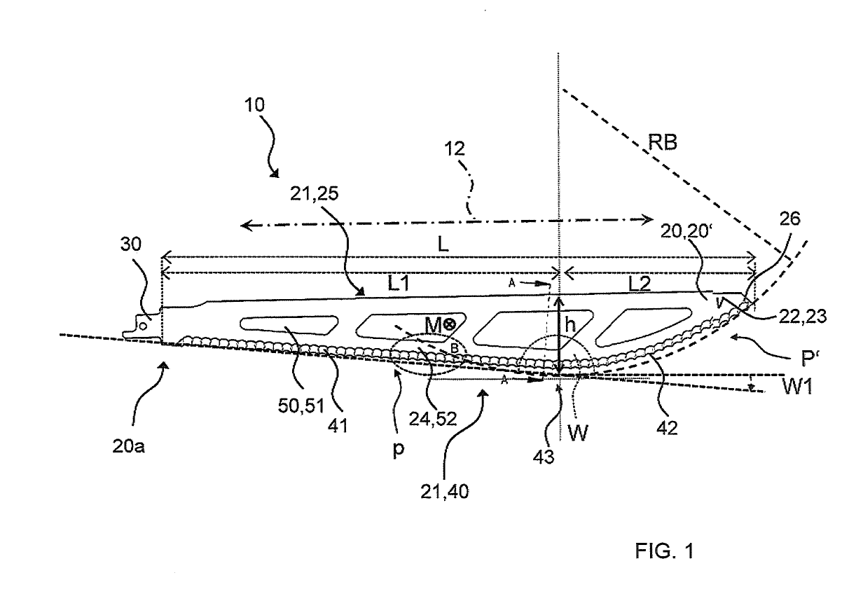

FIG. 1 shows a side view of a first exemplary embodiment of a reciprocating parting tool 10 according to the disclosure which is in the form of a cutting knife and is provided to be driven or moved at least along a direction of travel 12 when used for the parting processing of a workpiece (not illustrated) composed of fibrous materials, such as modern fiber materials or fiber composite materials, in particular modern sound-absorbing or insulating mats or boards. The reciprocating parting tool according to the disclosure is preferably driven or moved here in a manner oscillating axially in the direction of travel 12.

The exemplary reciprocating parting tool 10 according to the disclosure in FIG. 1 comprises a substantially flat parting blade 10 which extends along the direction of travel 12.

A parting blade 20 has two substantially flat side surfaces 22, 23 surrounded by an edge contour 21. The edge contour 21 here can be different in at least two sections—a back edge 25 and a parting edge 40, which extend substantially along the direction of travel 12 and are opposite each other. In the example according to FIG. 1 a, the back edge 25 and the parting edge 40 merge one into the other at a plunge-cutting point 26. However, it may also be advantageous if the back edge 25 and the parting edge 40 merge one into the other substantially directly or via further edge sections of differing contour.

A plug-in unit 30 for inserting the reciprocating parting tool 10 into a tool-holding fixture (not illustrated) of a power-driven, in particular motor-driven parting apparatus is provided in an end region 20a of the parting blade 20, which end region is opposite the plunge-cutting point 26. The tool-holding fixture here of the parting apparatus is preferably provided to be driven, during operation of the parting apparatus, at least along a direction which is substantially parallel to the direction of travel 12, in particular to be driven in an oscillating manner along said direction. A person skilled in the art here knows a multiplicity of parting apparatuses of this type, such as, for example, power hacksaws, compass saws or saber saws, for the tool-holding fixtures of which, in turn, a plurality of differently configured plug-in units are known and can be used alternatively in addition to the embodiment of the plug-in unit 30 which is illustrated in FIG. 1, without restricting the disclosed concept. Alternatively, the plug-in unit 30 can also be configured for connection to a handle device for the manual driving of a parting tool 10 according to the disclosure.

The parting edge 40 of the reciprocating parting tool 10 according to the disclosure from FIG. 1 extends along a longitudinal extent L with respect to the direction of travel 12. In the preferred embodiment according to FIG. 1, the longitudinal extent L here is at least 300 mm, in particular between 310 and 400 mm, preferably between 320 and 350 mm, particularly preferably approximately 330 mm The separating edge 40 here can be differentiated in two edge sections 41, 42, wherein the first edge section 41 is formed substantially rectilinearly, while the second edge section 42 is formed in a curved manner, in particular curved convexly with respect to the parting blade 20, particularly preferably configured to be curved in the shape of an arc of a circle.

The first edge section 41 extends over a longitudinal extent L1 with respect to the direction of travel 12 and, according to FIG. 1, forms an angle W1, which is in particular between 5° and 20°, preferably between 7° and 14°, particularly preferably between 9° and 12°, in the specific example around approximately 10°, with the direction of travel 12. The first edge section 41 therefore does not run parallel to the direction of travel 12 but rather is inclined away therefrom. In the preferred embodiment according to FIG. 1, the longitudinal extent L1 is at least 60%, in particular at least 70%, preferably at least 75%, of the longitudinal extent L. In the example according to FIG. 1, the longitudinal extent L1 is in particular between 180 and 300 mm, preferably between 190 mm and 240 mm, particularly preferably approximately 200 mm.

The second edge section 42 extends with respect to the direction of travel 12 over a longitudinal extent L2 which is preferably less than 60% of the longitudinal extent L1 of the first edge section 41, in particular is no more than approximately 50% of the longitudinal extent L1, preferably is no more than 40% of the longitudinal extent L1, particularly preferably is no more than 30% of the longitudinal extent L1. In the preferred embodiment according to FIG. 1, the longitudinal extent L2 is approximately 50% of the longitudinal extent L1. According to FIG. 1, the second edge section 42 is configured in the shape of an arc of a circle, wherein an arc radius BG of the section of the arc of the circle is preferably greater than the longitudinal extent L2 of the second edge section 42 and here is particularly preferably smaller than the longitudinal extent L1 of the first edge section 41. In the preferred embodiment according to FIG. 1, the arc radius is between 130 and 170 mm, preferably between 140 and 160 mm, particularly preferably approximately 150 mm.

In the preferred embodiment according to FIG. 1, the first edge section 41 merges substantially directly into the second edge section 42. The first edge section 41 here encloses an angle W, which is in particular between 5° and 15°, preferably between 7° and 13°, particularly preferably around approximately 10°, with a tangent of the section of the arc of the circle of the second edge section 42 at the transition point 43. The transition between the first edge section 41 and the second edge section 42 here is preferably formed substantially continuously or as a continuous transition at the transition point 43.

The back edge 25 of the reciprocating parting tool 10 according to the disclosure from FIG. 1 extends substantially rectilinearly and substantially parallel to the direction of travel 12. In conjunction with the parting edge 40 formed from the two edge sections 41, 42, the parting blade 20 obtains an inconstant transverse extent, as seen over the longitudinal extent L. A maximum of said transverse extent is achieved here at an axial position of the transition point 43 with respect to the longitudinal extent L. Said maximum defines a blade height h of the parting blade 20. An aspect ratio L/h of longitudinal extent L and blade height h here is preferably at least 6.0, preferably at least 7.0, particularly preferably at least 8.0. Ideally, a value of approximately 11.0 is not exceeded here. As a result, firstly, particularly good stability of the parting blade 20 against fracture is obtained, while, secondly, directional controlling of cutting progress during a parting process is not unfavorably affected.

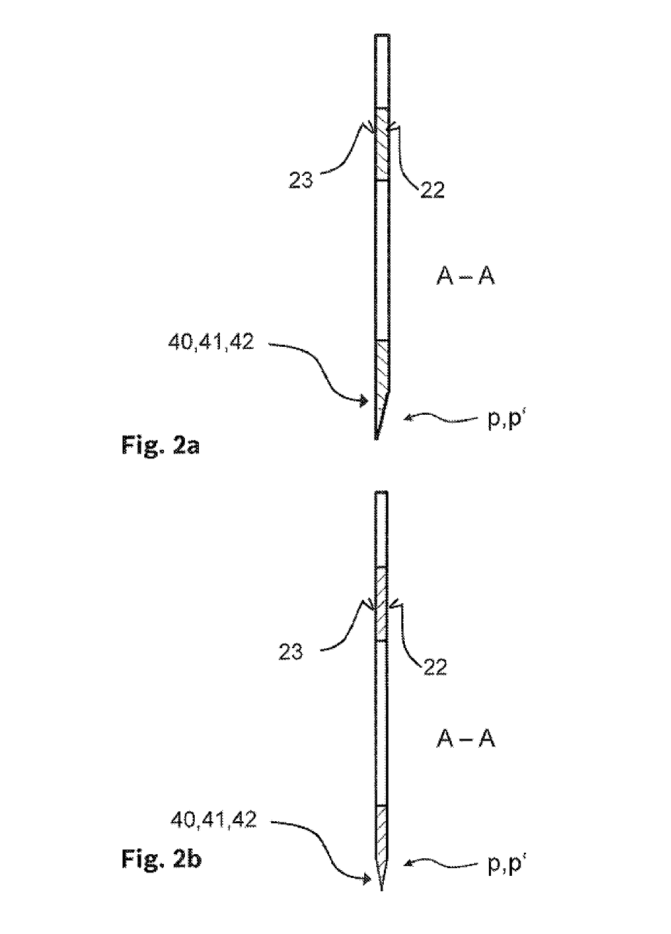

Along the first edge section 41, according to FIG. 1, a serrated knife edge with a serration spacing p is provided at least in one side surface 22, 23 of the parting blade 20. For this purpose, FIG. 2a shows a sectional view through the parting blade 20 according to the disclosure along the line A-A from FIG. 1. According to FIG. 2a, the serrated knife edge with the serration spacing p towards the side surface 22 is provided on one side in the blade body 20′ of the parting blade 20. However, it may also be advantageous if the serrated knife edge is provided on one side in the side surface 23 along the edge section 41 of the parting edge 40 of the parting blade 20. FIG. 2b shows a further advantageous embodiment, wherein the parting edge 40 or the first edge section 41 has a serrated knife edge which is ground into the two side surfaces 22, 23 and has the serration spacing p. The serrated knife edge here is preferably substantially symmetrical with respect to the side surfaces 22, 23, i.e. is formed with a substantially identical depth. However, it may also be advantageous to form the serrated knife edges on both sides with different depths, i.e. asymmetrically with respect to the side surfaces 22, 23.

Along the second edge section 42, according to FIG. 1, a serrated knife edge with a serration spacing p′ is provided at least in one side surface 22, 23 of the parting blade 20. According to FIG. 2a, the serrated knife edge with the serration spacing p′ towards the side surface 22 is provided on one side in the blade body 20′ of the parting blade 20. Analogously to the first edge section 41, it may also be advantageous if the serrated knife edge is provided on one side in the side surface 23 along the second edge section 42 of the parting edge 40 of the parting blade 20. FIG. 2b shows a further advantageous embodiment, wherein the parting edge 40 or the second edge section 42 has a serrated knife edge which is ground into the two side surfaces 22, 23 and has the serration spacing p′. The serrated knife edge here is preferably formed substantially symmetrically, i.e. with a substantially identical depth, with respect to the side surfaces 22, 23. However, it may also be of advantage to form the serrated knife edges on both sides with different depths, i.e. asymmetrically with respect to the side surfaces 22, 23.

The serrated knife edges of the two edge sections 41, 42 are preferably formed identically with respect to their arrangement on the side surfaces 22, 23. However, it may also be advantageous if a different arrangement is provided—for example, the serrated knife edge is formed with the serration spacing p of the first edge section 41 towards the side surface 22, while the serrated knife edge is formed with the serration spacing p′ of the second edge section 42 towards the side surface 23; or else the other way around; or one of the two edge sections 41, 42 is formed with a serrated knife edge formed on both sides, while the other is formed with a serrated knife edge on one side or on both sides, but with a differing position.

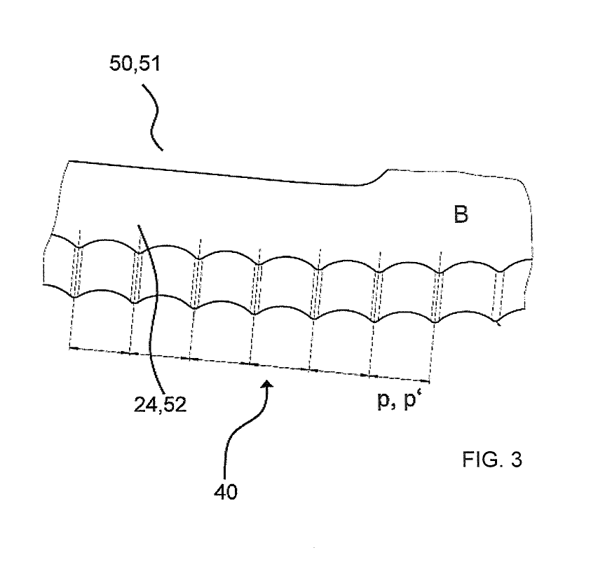

A serration space p, p′ here is understood as meaning a longitudinal extent of an individual serration, as illustrated in FIG. 3. In the preferred embodiment of a parting blade 20 according to the disclosure from FIG. 1, a serration spacing p, p′ is between 4.0 and 7.0 mm, preferably between 4.5 and 6.0 mm, particularly preferably approximately 5.0 mm. A ratio L/p of the longitudinal extent L of the parting edge 40 and the serration spacing p is preferably at least 40, preferably at least 50, particularly preferably at least 60, ideally at least 65, as a result of which the cutting progress or a cutting speed in fibrous sound-absorbing materials is particularly improved. The two serration spacings p, p′ are preferably formed substantially identically, with it possibly also being advantageous if different serration spacings p, p′ are selected.

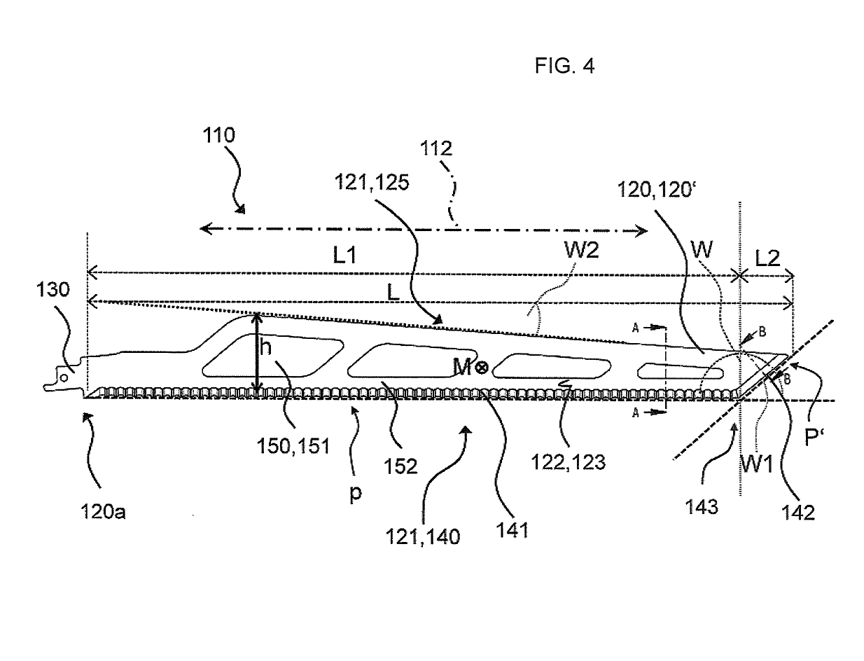

It may in principle also be advantageous if the second edge section 42 is provided with a sharpened knife edge, in particular with a smooth, flat sharpened knife edge, instead of with a serrated knife edge. An embodiment of this type is illustrated in the exemplary embodiment according to FIG. 4.

In the embodiment of the reciprocating parting tool 10 according to the disclosure from FIG. 1, the parting blade 20 has a total of four impressions, recesses and/or cutouts 50 in at least the visibly depicted side surface 22. The four impressions, recesses and/or cutouts 50 are preferably also provided in the side surface 23 substantially symmetrically with respect to a plane defined by the back edge 25 and the parting edge 40. In a particularly preferred embodiment, the four impressions, recesses and/or cutouts 50 are configured as apertures 51 which, in particular, completely pass through the blade body 20′. Apertures 51 of this type can be introduced into the blade body 20′, for example, by punching, cutting, eroding and/or machining The four impressions, recesses and/or cutouts 50, 51 are preferably configured as polygonal contours, wherein, particularly preferably, the corners between every two adjacent contour lines or contour edges are formed in a rounded manner. As a result, stresses with the blade body 20′ are advantageously reduced. In the preferred embodiment according to FIG. 1, the four impressions, recesses and/or cutouts 50, 51 are arranged in the side surfaces 22, 23 substantially uniformly over the longitudinal extent L. The remaining blade body 20′ here, which surrounds the respective impression, recess and/or cutout 50, 51, forms a border region 52 or a frame which confers an advantageous degree of rigidity on the parting blade 20.

By means of the arrangement of the impressions, recesses and/or cutouts 50, 51 in the parting blade 20, the position of a center of gravity M of the reciprocating parting tool 10 according to the disclosure can furthermore be advantageously configured or arranged for the mechanical drive thereof. The position of the center of gravity M obtains increased importance in particular in conjunction with operating loadings of the reciprocating parting tool 10, the tool-holding fixture and/or a drive train of a parting apparatus, said drive train driving the tool-holding fixture. Furthermore, the characteristic frequencies of the reciprocating parting tool 10 according to the disclosure can advantageously be set preferably via the number and/or configuration of the impressions, recess and/or cutouts 50, 51, and therefore an oscillating behavior of the reciprocating parting tool 10 can be matched to the boundary conditions during use.

FIG. 4 shows a second exemplary embodiment of a reciprocating parting tool 110 according to the disclosure. In the depiction below, identical or identically acting features obtain a reference number incremented by 100, but reference is made at this juncture to the previous description of FIGS. 1 to 3 for the detailed description of said features, said description applying analogously also to the exemplary embodiment of FIG. 4. Therefore, only the differences from the first exemplary embodiment are described in detail below.

The reciprocating parting tool 110 comprises a parting blade 120 which has two side surfaces 122, 123 surrounded by an edge contour 121. Analogously to the embodiment according to FIG. 1, the edge contour 121 comprises at least one back edge 125 and a parting edge 140, which extends substantially along a direction of travel 121 and substantially lie opposite each other. The parting edge 140 here has a longitudinal extent L with respect to the direction of travel 121. In the preferred embodiment according to FIG. 4, the longitudinal extent L here is at least 300 mm, in particular at least 350 mm, preferably between 360 and 400 mm, particularly preferably approximately 380 mm.

As in the exemplary embodiment according to FIG. 1, the back edge 125 is formed rectilinearly, said back edge preferably being formed inclined at an angle W2 in relation to the direction of travel 121. In a preferred embodiment, the angle W is between 1° and 10°, particularly preferably between 2° and 6°, ideally approximately 4°.

According to FIG. 4, the parting edge 140 comprises two edge sections 141, 142, wherein the first edge section 141 is formed rectilinearly and substantially parallel to the direction of travel 121.

According to FIG. 4, the first edge section 141 here extends over a longitudinal extent L1 parallel to the direction of travel 121. In this preferred embodiment according to FIG. 4, the longitudinal extent L1 is at least 70%, in particular at least 80%, preferably at least 85% of the longitudinal extent L. In the example according to FIG. 4, the longitudinal extent L1 is in particular between 210 and 380 mm, preferably between 300 mm and 360 mm, particularly preferably approximately 340 mm.

The second edge section 142 of the embodiment according to FIG. 4 as a result from the first exemplary embodiment of a reciprocating parting tool 10 in accordance with the disclosure in that a longitudinal extent L2 of the second edge section 142 is only between 5% and 15% of the longitudinal extent L1, in particular merely is a maximum of 45 mm, preferably a maximum of 40 mm, particularly preferably a maximum of 35 mm.

Contrary to the example according to FIG. 1, in this embodiment the second edge section 142 is likewise formed substantially rectilinearly. The second edge section 142 here encloses an obtuse angle W with the first edge section 141, wherein the angle W is in particular between 120° and 160°, preferably between 130° and 150°, particularly preferably around approximately 140°. In the embodiment according to FIG. 4, the two edge sections 141, 142 therefore merge directly one into the other essentially at a transition point 143, but, contrary to the first exemplary embodiment, the transition here is formed discontinuously or as a discontinuous transition. Furthermore, the second edge section 142 forms an angle W1 with the direction of travel 112, which angle is between 10° and 70°, preferably between 20° and 60°, in particular preferably between 30° and 50°, and particularly preferably approximately 40°.

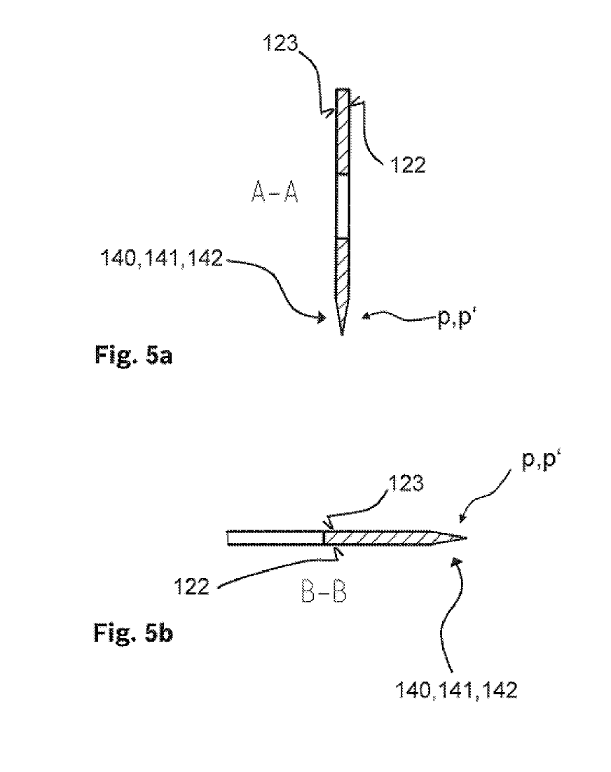

According to FIG. 4, along the first edge section 141, a serrated knife edge with a serration spacing p is provided at least in one side surface 122, 123 of the parting blade 120. To this end, FIG. 5a shows a sectional view through the parting blade 120 according to the disclosure along the line A-A from FIG. 4. According to FIG. 5a, the serrated knife edge is provided with the serration spacing p towards the two side surfaces 122, 123, i.e. on both sides, in the blade body 120′ of the parting blade 120. The parting edge 140 or the first edge section 141 therefore has a serrated knife edge which is ground into the two side surfaces 122, 123 and has the serration spacing p. The serrated knife edge here is preferably formed substantially symmetrically, i.e. at a substantially identical depth, with respect to the side surfaces 122, 123. However, it can also be advantageous to form the serrated knife edges on both sides with differing depths, i.e. asymmetrically with respect to the side surfaces 122, 123. However, it may also be advantageous if the serrated knife edge is provided on one side in one of the two side surfaces 122, 123 along the edge section 141 of the parting edge 140 of the parting blade 120, as shown by way of example in FIG. 2a.

According to FIG. 4, along the second edge section 142, a sharpened knife edge, in particular a substantially flat, smooth sharpened knife edge, is provided at least in one side surface 122, 123 of the parting blade 120. According to FIG. 5b, the sharpened knife edge is provided towards the two side surfaces 122, 123, i.e. on both sides, in the blade body 120′ of the parting blade 120. The parting edge 140 or the first edge section 141 therefore has a sharpened knife edge ground into the two side surfaces 122, 123. The sharpened knife edge here is preferably formed substantially symmetrically, i.e. substantially at an identical depth, with respect to the side surfaces 122, 123. However, it may also be advantageous to form the sharpened knife edges on both sides with differing depths, i.e. asymmetrically with respect to the side surfaces 122, 123. However, it may also be advantageous if the sharpened knife edge is provided on one side in one of the two side surfaces 122, 123 along the edge section 141 of the parting edge 140 of the parting blade 120, as shown by way of example in FIG. 2a.

A further advantageous modification of the second exemplary embodiment can be obtained if the second edge section 142 has a serrated knife edge with a serration spacing p′.

In preferred embodiments of a parting blade 120 according to the disclosure from FIG. 4, a serration spacing p, p′ is between 4.0 and 7.0 mm, preferably between 4.5 and 6.0 mm, particularly preferably approximately 5.0 mm. A ratio L/p of the longitudinal extent L of the parting edge 140 and the serration spacing p is preferably at least 40, preferably at least 50, particularly preferably at least 60, ideally at least 65, thus particularly improving the cutting progress or a cutting speed in fibrous sound-absorbing materials. The two serration spacings p, p′ are preferably formed substantially identically, with it possibly also being advantageous if different serration spacings p, p′ are selected.

A second edge section 142 configured as per FIG. 4 is suitable in particular for the plunge-cutting into a workpiece at the beginning of a processing operation, in particular parting operation. The first edge section 141 which is particularly long particularly in relation to the second edge section 142 in turn permits neat processing of particularly thick workpieces, in particular fibrous sound-absorbing materials. Furthermore, the angle W between the two edge sections 141, 142 promotes a transition from the plunge-cutting operation to the parting operation.

In the embodiment of the reciprocating parting tool 110 according to the disclosure from FIG. 4, the parting blade 120 has a total of four impressions, recesses and/or cutouts 150 in at least the visibly depicted side surface 122. The four impressions, recesses and/or cutouts 150 are preferably also provided in the side surface 123 substantially symmetrically with respect to a plane defined by the back edge 125 and the parting edge 140. In a particularly preferred embodiment, the four impressions, recesses and/or cutouts 150 are configured as apertures 151 which, in particular, pass completely through the blade body 120′. Apertures 151 of this type can be introduced into the blade body 120′, for example, by punching, cutting, eroding and/or machining The four impressions, recesses and/or cutouts 150, 151 are preferably formed as polygonal contours, wherein, particularly preferably, the corners between every two adjacent contour lines or contour edges are formed in a rounded manner. This advantageously reduces stresses with the blade body 120′. In the preferred embodiment according to FIG. 4, the four impressions, recesses and/or cutouts 150, 151 are arranged in the side surfaces 122, 123 substantially uniformly over the longitudinal extent L. The remaining blade body 120′ here, which surrounds the respective impression, recess and/or cutout 150, 151, forms a border region 152 or a frame which imparts an advantageous degree of rigidity on the parting blade 120.

Furthermore, the position of a center of gravity M of the reciprocating parting tool 110 according to the disclosure can be advantageously configured or arranged for mechanical drive thereof by means of the arrangement of the impressions, recesses and/or cutouts 150, 151 in the parting blade 120. The position of the center of gravity M obtains increased importance in particular in conjunction with operating loadings of the reciprocating parting tool 110, the tool-holding fixture or a drive train of a parting apparatus, said drive train driving the tool-holding fixture. Furthermore, the characteristic frequencies of the reciprocating parting tool 110 according to the disclosure can be advantageously set preferably via the number and/or configuration of the impressions, recesses and/or cutouts 150, 151, as a result of which an oscillating behavior of the reciprocating parting tool 110 can be matched to the boundary conditions during use.

Further embodiments according to the disclosure of a reciprocating parting tool are obtained by a person skilled in the art, inter alia, by means of a combination and variation of the features described previously. For example, it can be advantageous to match the number and/or the arrangement of the impressions, recesses and/or cutouts 50, 51, 150, 151 to the requirements of the respective intended use. Also, instead of or in addition to the apertures 51, 151 described, impressions can be provided for changing an oscillating behavior of the reciprocating parting tool 10, 110.

Furthermore, it can be advantageous if at least one of the serration spacings p, p′ is formed inconstantly, in particular progressively in or counter to the direction of travel 12, 112, preferably monotonously progressively. A progressive serration spacing P here is understood as meaning in particular a serration spacing which changes, preferably changes monotonously, along the longitudinal extent L, L1, L2. It can be provided here that the serration spacing P changes from one individual serration to the next individual serration, and/or that groups of individual serrations are provided with a respectively constant group serration spacing.

Furthermore, it can be advantageous if the back edge 25, 125 of the parting blade 20, 120 is not formed rectilinearly, as in the examples shown, but rather is formed in a curved manner and/or rectilinearly in sections.

The parting blade 20, 120 is preferably manufactured from a metal or a metal alloy, in particular from steel, preferably tool steel. Particularly preferred embodiments of the parting blade 20, 120 are essentially manufactured from C100S (1.1274), 58CrV4 (1.816), C67S (1.1231), C75 (1.0605) or X46Cr13 (1.4034). A blank of the parting blade 20, 120 here can preferably be manufactured by means of cutting, in particular laser cutting, punching and/or machining, and preferably in conjunction with a heat treatment, thus forming a blade body 20′, 120′. The preferred parting blade 20, 120 here obtains a hardness of at least 53 HRC, preferably at least 55 HRC, particularly preferably at least 57 HRC. In a particularly preferred embodiment, the hardness is around 57±2 HRC.

In a particularly preferred manufacturing variant, the reciprocating parting tool 10, 110 according to the disclosure, in particular the cutting knife, is manufactured from a metallic blank or blade body 20′, 120′ pre-tempered at a hardness of approximately 57±2 HRC. The preferred embodiment of the edge contour 21, 121, in particular of the back edge 25, 125 and/or of the parting edge 40, 140, and/or a texturing of the blade body 20′, 120′, for example with impressions, recesses and/or cutouts 50, 51, 150, 151, is formed subsequently preferably by means of laser cutting or other cutting methods or is introduced into the blade body 20′, 120′.

In these embodiments, an alternative or additional possibility is inductively to overharden the parting blade 20, 120, in particular the parting edge 40, 140—before or after sharpening, in order to increase the service life because of the greater hardness. A hardness of approximately 850 HV0.5 at the parting edge 40, 140 has been particularly preferably set in this case.

A further development which is particularly to be preferred of a reciprocating parting tool according to the disclosure is achieved by the embodiment in the form of a bimetal parting tool, in particular a bimetal knife. A bimetal parting tool here is understood as meaning in particular a parting tool 10, 110, in which at least the blade body 20′, 120′ and the parting edge 40, 140 are composed of two different metallic materials. In an advantageous embodiment in the form of a bimetal parting tool 10, 110, the parting edge 40, 140, in particular a cutting part, is manufactured from HSS wire—for example from HS6-5-2, 1.3343 or matrix II—and while the blade body 20′, 120′ is preferably manufactured from an HCS steel, for example from 46CrMoV4/10. In this variant, the HSS wire, which preferably has a rectangular or square cross section, is connected in an integrally bonded manner, preferably welded, particularly preferably welded by means of laser, to the HCS blade body 20, 120′. In a variant of this type, the HSS wire or the parting edge 40, 140 preferably has a hardness of approximately 800-900 HV10, while the blade body 20′, 120′ preferably approximately has a hardness of between 45-50 HRC.

Further embodiments according to the disclosure of a reciprocating parting tool are obtained by a person skilled in the art, inter alia, by means of a combination and variation of the features described previously.

What is claimed is:

1. A reciprocating parting tool, comprising:
a substantially flat parting blade configured to extend along a direction of travel and having a longitudinal extent along the direction of travel, the parting blade including:
at least one parting edge configured to extend substantially along the longitudinal extent and having at least two edge sections,
wherein at least one of the at least two edge sections is not oriented parallel to the direction of travel, and
wherein a first edge section of the at least two edge sections has a serrated knife edge with a first serration spacing.

2. The reciprocating parting tool according to claim 1, wherein:
a second edge section of the at least two edge sections has a sharpened knife edge with a second serration spacing, and
the second serration spacing substantially corresponds to the first serration spacing.

3. The reciprocating parting tool according to claim 1, wherein:
the parting blade further includes two flat side surfaces which lie in a plane defined by a back edge and the at least one parting edge, and
at least one of the serrated knife edge and the sharpened knife edge is formed at least towards one side surface.

4. The reciprocating parting tool according to claim 3, wherein the parting blade further includes at least one impression, recess and/or cutout in at least one of the side surfaces.

5. The reciprocating parting tool according to claim 4, wherein a plurality of recesses distributed substantially uniformly over the longitudinal extent are provided in the parting blade.

6. The reciprocating parting tool according to claim 4, wherein:
the at least one impression, recess and/or cutout is substantially bounded by polygonal or elliptical contours.

7. The reciprocating parting tool according to claim 1, wherein:
the at least two edge sections merge into each other at a transition, and
the at least two edge sections enclose an angle of between 90° and 180° at the transition.

8. The reciprocating parting tool according to claim 1, wherein:
the parting blade has an inconstant transverse extent, as seen over the longitudinal extent, and
a maximum of the transverse extent defines a blade height of the reciprocating parting tool.

9. The reciprocating parting tool according to claim 8, wherein an aspect ratio of longitudinal extent to blade height is at least 6.0.

10. The reciprocating parting tool according to claim 2, a second longitudinal extent of the second edge section is less than 60% of a first longitudinal extent of the first edge section.

11. The reciprocating parting tool according to claim 1, wherein the parting blade further includes at least one end region including with a plug-in unit configured for inserting the reciprocating parting tool into a tool-holding fixture of a power-driven parting apparatus.

12. The reciprocating parting tool according to claim 1, wherein the first edge section encloses an angle that is greater than 0° and smaller than 45° with the direction of travel.

13. The reciprocating parting tool according to claim 12, wherein the second edge section is curved towards the direction of travel.

14. The reciprocating parting tool according to claim 13, wherein the second edge section is curved in the shape of an arc of a circle.

15. The reciprocating parting tool according to claim 1, wherein the second edge section is formed substantially rectilinearly and is configured to enclose an angle of between 10° and 70° with the direction of travel.

16. The reciprocating parting tool according to claim 2, wherein the second serration spacing is identical to the first serration spacing.

17. The reciprocating parting tool according to claim 3, wherein the at least one of the serrated knife edge and the sharpened knife edge is formed toward the two side surfaces.

18. The reciprocating parting tool according to claim 5, wherein the recesses are surrounded by a substantially uniform border region formed by a blade body of the parting blade.

19. The reciprocating parting tool according to claim 6, wherein:
the at least one impression, recess, and/or cutout has a triangle-like, trapezoidal, rhombic, or rectangular cross section, and
corners between every two contour lines or contour edges are formed in a rounded manner.

20. The reciprocating parting tool according to claim 8, wherein the maximum of the transverse extent is reached only at one position along the longitudinal extent.
